(19) United States
(12) Patent Application Publication
(10) Pub. No.: US 2007/0115899 A1
(43) Pub. Date: May 24, 2007

(54) Method, apparatus and system architecture for performing handovers between heterogeneous wireless networks

(76) Inventors: Shlomo Ovadia, San Jose, CA (US); Christian Maciocco, Tigard, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/285,616

(22) Filed: Nov. 22, 2005

(51) Int. Cl. H04Q 7/24

(52) U.S. Cl. 370/338; 370/401

(57) ABSTRACT

Method, apparatus, and system architecture for performing handovers between heterogeneous wireless networks. While receiving wireless service from a base station for a first wireless network, a mobile subscriber station (MSS) device roams within range of one or more access points (APs) corresponding to a second wireless network. The MSS obtains parameters for each AP quantifying the wireless service available via that AP. The parameters are employed as inputs to a handover decision algorithm to determine if a handover of service from the first wireless network to an AP for the second wireless network is to be performed. In one embodiment, the handover decision algorithm is effected via a fuzzy logic controller that is implemented via execution of software on the MSS.

### FIELD OF THE INVENTION

The field of invention relates generally to wireless communication networks and, more specifically but not exclusively relates to a method, apparatus and system for performing handovers between heterogeneous wireless networks.

### BACKGROUND INFORMATION

In recent years, network reach and flexibility has been greatly enhanced through the development and deployment of wireless networks. Among the many different wireless protocols now available (e.g., Wi-Fi, Bluetooth, infrared, various cellular transmission schemes, WiMax, etc.), a large number of wireless networks deployed today employ wireless network components that operate under the IEEE (Institute for Electronic and Electrical Engineers) 802.11 suite of standards.

The most prevalent WLAN (wireless local area network) deployments, commonly referred to as “Wi-Fi” (wireless fidelity) networks, employ an air interface operating in the 2.4-gigahertz (GHz) (802.11b, 802.11g) or 5 GHz (802.11a) frequency range. The original Wi-Fi standard was developed by the Wireless Ethernet Compatibility Alliance (WECA), and is based on the IEEE 802.11 specification. The IEEE Standard provides support for three different kinds of PHY layers, which are an InfraRed (IR) baseband PHY, a frequency-hopping spread spectrum (FHSS) and a direct-sequence spread spectrum (DSSS) PHY operating at either 2.4 GHz or 5 GHz frequency band. For IEEE 802.11b, this results in a bandwidth of up to 11 megabits per second (Mb/s) when an appropriate signal strength is available. IEEE 802.11g defines a similar standard to Wi-Fi, with backward compatibility to 802.11b. However, 802.11g employs orthogonal frequency-division multiplexing (OFDM) rather than DSSS, and supports bandwidth up to 54 Mb/s. Enhanced implementations of 802.11g are asserted by their manufacturers to support transfer rates of up to 108 Mb/s. WLAN equipment employing the IEEE 802.11a standard has also been recently introduced. The 802.11a standard employs a 5 GHz air interface using an OFDM carrier. For convenience, the terms IEEE 802.11, 802.11 and Wi-Fi are used interchangeably throughout this specification to refer to the IEEE 802.11 suite of air interface standards.

While Wi-Fi networks provide several advantages over wired networks and other short-range wireless transmission schemes, they are somewhat limited in reach (i.e., coverage area). For example, a typical Wi-Fi network might have a reach of approximately 1000 feet or less, and sometimes much less if within a building or house having structure that adversely affects signal strength. While Wi-Fi networks can be extended using additional access points, the combined coverage area of a Wi-Fi network is still relatively limited.

In view of this and other considerations, the IEEE has recently promulgated the IEEE 802.16 suite of air interface standards for combined fixed, portable and Mobile Broadband Wireless Access (MBWA). Initially conceived as a radio standard to enable cost-effective “last-mile” broadband connectivity to those not served by wired broadband such as cable or DSL, the specifications are evolving to target a broader market opportunity for mobile, high-speed broadband applications. The IEEE 802.16 Standard based architecture not only addresses the traditional “last mile” problem, but also supports nomadic and mobile clients on the go. The MBWA architecture is being standardized by the IEEE 802.16 Mobile Technical Working Group and the Worldwide Interoperability for Microwave Access (WiMAX) forum. The IEEE 802.16 suite of Standards typically operates at radio frequencies below 11 GHz. For convenience, the terms IEEE 802.16, 802.16 and WiMAX are used interchangeably throughout this specification to refer to the IEEE 802.16 suite of air-interface standards.

It is contemplated that combination of WiMAX and Wi-Fi wireless networks may be deployed in which mobile coverage is provided for subscribers using a combination of WiMAX and Wi-Fi infrastructure. For example, while WiMAX networks provide greater reach the Wi-Fi networks, they sometimes may not work well within some buildings or proximate to certain terrain conditions (e.g., buildings, hills, etc.). As discussed above, the reach of Wi-Fi networks, in comparison to WiMAX networks, is relatively limited. Thus, it would be advantageous to have a “seamless” service network that would enable subscribers to move within combined WiMAX and Wi-Fi coverage areas without losing wireless service. Among other considerations, implementation of such a combination network necessitates some mechanism for determining under what conditions service handovers between associated WiMAX base stations and Wi-Fi network access points should occur, and how to effect such handovers.

It is further contemplated that mobile devices will be developed that support service from other types of heterogeneous wireless networks, enabling such mobile devices to switch services between such wireless networks. For example, such mobile devices may support access to both WiMAX networks and cellular networks, or to both Wi-Fi networks and cellular networks. Still other mobile devices may support access to Wi-Fi networks, WiMAX networks, and cellular networks. Accordingly, there is a need for a mechanism for determining under what conditions handover of service between such heterogeneous wireless networks should occur.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram of an exemplary WiMAX network;

FIG. 2 is a schematic diagram of an exemplary Wi-Fi network;

FIG. 3 is a schematic diagram illustrating the coverage areas for the WiMAX network base stations of FIG. 1 and the Wi-Fi network access points of FIG. 2;

FIG. 4 is a flowchart illustrating operations and logic performed during one embodiment of a handover decision process;

FIG. 5 is a block diagram of a fuzzy logic controller used to implement a handover decision algorithm employed by the handover decision process of FIG. 4;

FIG. 6 is flowchart illustrating operating and logic employed in connection with implementing a handover decision algorithm via the fuzzy logic controller of FIG. 5;

FIG. 7 is a schematic diagram of a combination of WiMAX and Wi-Fi infrastructure for illustrating exemplary handover processes between WiMAX and Wi-Fi networks; and

FIG. 8 is a schematic diagram of an exemplary Mobile Subscriber Station (MSS) implemented on a host device comprising a notebook computer.

### DETAILED DESCRIPTION

Embodiments of methods, apparatus, and system architectures for facilitating handovers between heterogeneous wireless networks are described herein. In the following description, numerous specific details, such as exemplary handovers between WiMAX and Wi-Fi networks, are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In accordance with aspects of the embodiments now described, novel techniques are disclosed for effecting handovers between heterogeneous wireless networks. As used herein, heterogenous wireless networks mean wireless networks that employ different physical signaling schemes and/or protocols via separate network infrastructure. For example, WiMAX and Wi-Fi wireless networks use different signaling at the physical and media access layers, and each network requires is own set of network infrastructure. Similarly, cellular networks use different signaling and protocols than WiMAX and Wi-Fi networks, and have their own set of infrastructure. In addition to the handover schemes, mechanisms for implementing the schemes within mobile subscriber stations (MSSs) are also disclosed.

In order to more clearly understand principles and aspects of the inventive handover process, embodiments are presented below involving handovers between WiMAX and Wi-Fi networks. However, it will be understood that similar principles and techniques may be employed for handovers between WiMAX networks and cellular networks, and between Wi-Fi networks and cellular networks.

Exemplary WiMAX Infrastructure

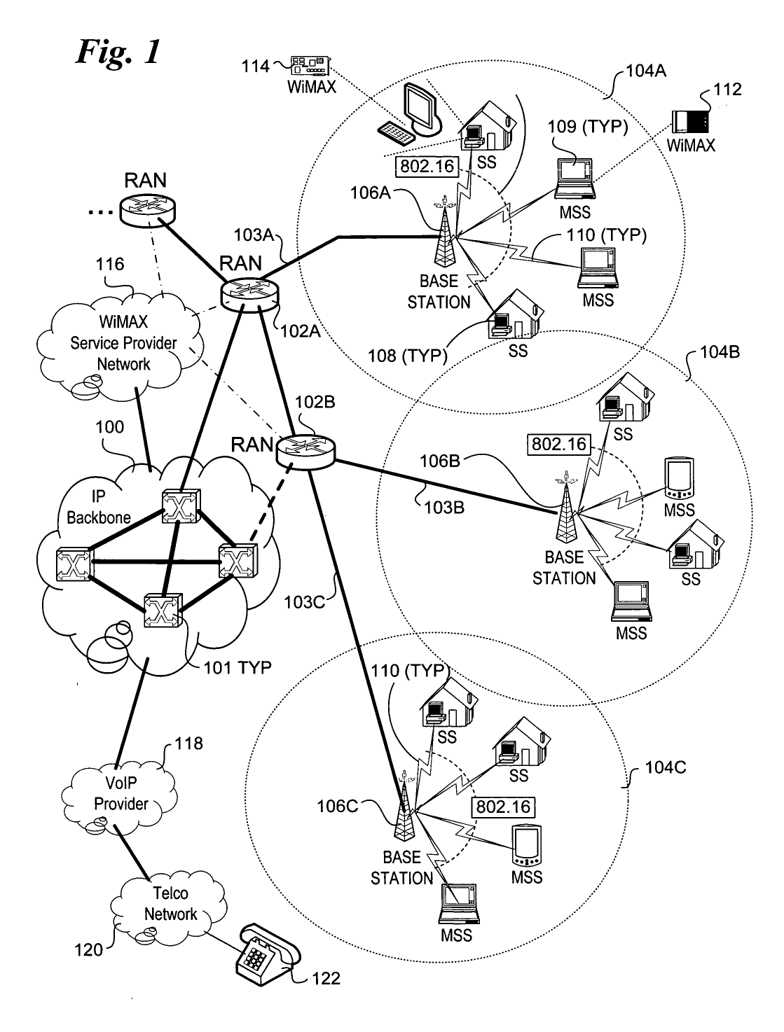

FIG. 1 shows a simplified exemplary WiMAX broadband wireless network with point-to-multipoint (PMP) cellular-like architecture for operation at both licensed and licensed-exempt frequency bands typically below 11 GHz. Other types of architectures (not shown) such as mesh broadband wireless networks are permissible. An IP (Internet Protocol) backbone network 100 including multiple network elements 101 (e.g., backbone switches and routers) is connected to a WiMAX broadband wireless network using radio access nodes (RANs), represented by RANs 102A-C. Each RAN is connected via a wired link such as an optical fiber (depicted as optical fiber links 103A, 103B and 103C) or point-to-point wireless link (not shown) to one or more radio cells (depicted between RAN 102A or 102B to radio cells 104A, 104B, and 104C). At the hub of a radio cell is a respective Base station (BS) 106A, 106B, and 106C. A Base Station system includes an advanced antenna system (AAS), which is typically located on top of a radio tower and is used to transmit high-speed data to multiple subscriber stations (SSs) 108 and mobile subscriber stations (MSSs) 109 and receive data from the subscriber stations via unidirectional wireless links 110 (each SS uplink transmission is independent on the others). More particularly, each SS 108 and MSS 109 can access network 100 (via an appropriate BS) using the PHY+MAC (Physical+Media Access Control) layer features defined by the IEEE P802.16 air-interface standard. An SS may correspond to a fixed subscriber location (e.g., in a home or office), or may correspond to a mobile subscriber who might access the broadband wireless network via a mobile device (MSS) such as a personal digital assistant (PDA), laptop computer, etc. A fixed SS typically uses a directional antenna while an MSS usually uses an omni-directional antenna.

Transmission of data bursts from network 100 to an SS 108 proceeds in the following manner. (It is noted that a similar process is used for MSSs 109.) The data bursts such as IP packets or Ethernet frames are encapsulated in IEEE 802.16 data frame format and forwarded from an appropriate RAN to an appropriate BS within a given cell. The BS then transmits non-line-of-sight (NLOS) data to each SS 108 using a unidirectional wireless link 110, which is referred to as a “downlink.” Transmission of data from an SS 108 to network 100 proceeds in the reverse direction. In this case, the encapsulated data is transmitted from an SS to an appropriate BS using a unidirectional wireless link referred to as an “uplink.” The data packets are then forwarded to an appropriate RAN, converted to IP Packets or Ethernet frames, and transmitted henceforth to a destination node in network 100. Data bursts can be transmitted using either Frequency-Division-Duplexing (FDD) or Time-Division-Duplexing (TDD) schemes. In the TDD scheme, both the uplink and downlink share the same RF channel, but do not transmit simultaneously, and in the FDD scheme, the uplink and downlink operate on different RF channels, but the channels are transmitted simultaneously.

Multiple BSs are configured to form a cellular-like wireless network. A network that utilizes a shared medium requires a mechanism to efficiently share it. Within each cell, the wireless network architecture is a two-way PMP, which is a good example of a shared medium; here the medium is the space (air) through which the radio waves propagate. The downlink, from the base station (BS) to an SS, operates on a PMP basis. Provisions within the IEEE 802.16 standard include a central BS with AAS within each cell. Such an AAS includes a sectorized antenna that is capable of handling multiple independent sectors simultaneously. Under this type of configuration, the operations of base stations described below may be implemented for each of the independent sectors, such that multiple co-located base stations with multiple sector antennas sharing a common controller may be employed in the network. Within a given frequency channel and antenna sector, all stations receive the same transmission, or parts thereof.

In the other direction, the subscriber stations share the uplink to the BS on a demand basis. Depending on the class of service utilized, the SS may be issued continuing rights to transmit, or the right to transmit may be granted by the BS after receipt of a request from an SS. In addition to individually-addressed messages, messages may also be sent on multicast connections (control messages and video distribution are examples of multicast applications) as well as broadcast to all stations. Within each sector, users adhere to a transmission protocol that controls contention between users and enables the service to be tailored to the delay and bandwidth requirements of each user application.

To support station-side operations, each SS or MSS provides an appropriate WiMAX interface, such as depicted by a PCMCIA WiMAX card 112 for a notebook computer or a WiMAX peripheral expansion card 114 for a desktop computer. Optionally, the WiMAX wireless interface may be built-in the SS or MSS.

Access to a WiMAX network will generally be via some form a subscription service offered by a WiMAX service provider. As such, the various WiMAX RANs 102A-C are depicted as being coupled to and managed by a WiMAX service provider network 116, further details of which are discussed below. It will be understood that the coupling between a given RAN and WiMAX service provider network 116 may be via a dedicated link (e.g., private trunk or the like), or through another communication means, such as via IP backbone network 100.

Exemplary Wi-Fi Infrastructure

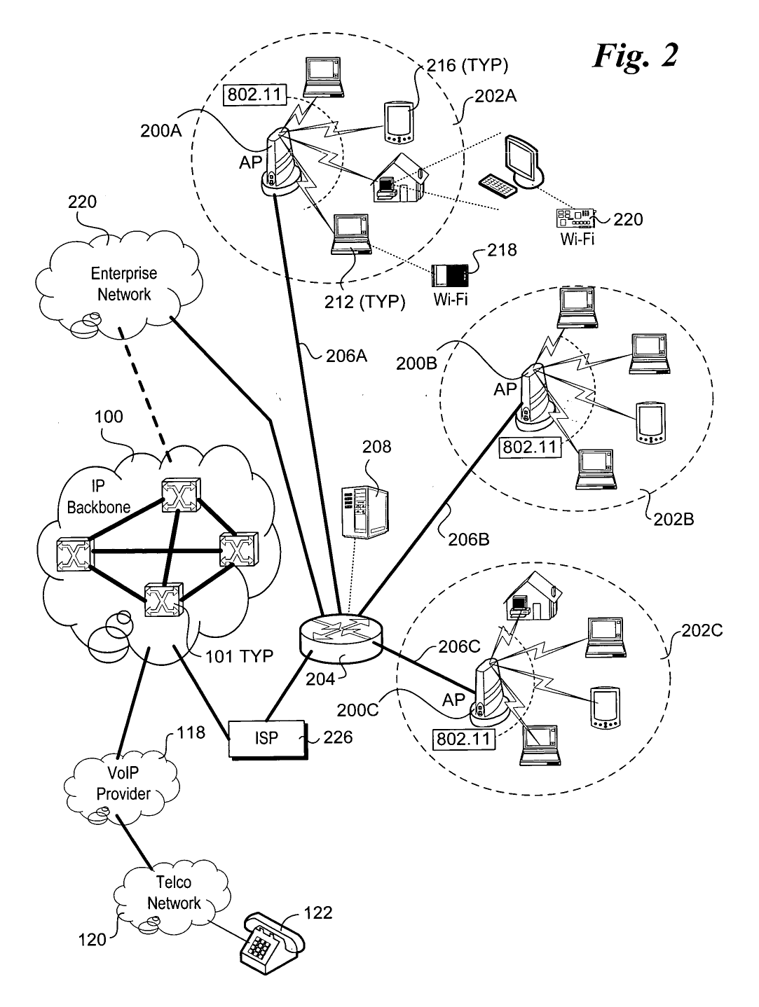

A typical 802.11 Wi-Fi WLAN deployment is shown in FIG. 2, wherein each of three base stations comprising wireless access points (APs) 200A, 200B, and 200C provide WLAN connectivity to various Wi-Fi stations within respective coverage areas 202A, 202B, and 202C. (As with WiMAX networks, Wi-Fi networks employ base stations to provide service to Wi-Fi clients within the coverage area of the base stations; however, such base stations are commonly referred to as wireless access points (APs). Accordingly, with respect to Wi-Fi networks, the terms “base station” and “access point” are used interchangeably.) Each of wireless APs 200A-C is linked to a switch/router 204 via a respective Ethernet (IEEE 802.3) link 206A-C. In general, switch 204 is representative of various types of switches and routers present in a typical LAN, WLAN (wide LAN) or MAN (Metropolitan Area Network) that employs wireless APs to extend their network reach. In some cases, the switching/routing operations may be facilitated via a network server 208 that runs software to manage the WLAN.

Each wireless AP 200A-C provides WLAN service to stations within its coverage area using wireless signals and protocols defined by the applicable air interface (typically 802.11a, b, and/or g) employed for the WLAN. (For illustrative purposes, each coverage area is shown in a circular shape, although in practice, the actual shape of a particular coverage area will generally vary based on various obstacles and signal interference from external sources. Additionally, each of coverage areas 202A-C is shown to not overlap any other coverage area. Again, this is for illustrative purposes, as WLAN coverage areas often overlap.) Exemplary WLAN stations depicted in FIG. 2 include notebook computers 212, desktop computers 214, and hand-held wireless devices 216 (e.g., personal digital assistants (PDAs), pocket PCs, cellular phones supporting 802.11 links, etc.).

To support station-side operations, each station provides an appropriate Wi-Fi interface, such as depicted by a PCMCIA Wi-Fi card 218 for a notebook computer or a Wi-Fi peripheral expansion card 220 for a desktop computer. Optionally, the Wi-Fi wireless interface may be built-in, such as is the case with notebooks employing Intel's Centrino® chipset. Similarly, wireless handheld devices will provide built-in Wi-Fi interfaces.

A wireless AP provides a basic and extended service set to one or more stations that communicate with the AP. The AP facilitates and coordinates communication and channel access between stations, and provides an access mechanism for the stations to access various land-based networks via switch 204, such as depicted by enterprise network 222 and IP backbone 224. Stations authenticated and associated with an AP typically do not operate in a peer-to-peer mode—communication from one station to another is routed through the AP. Thus, the AP serves as a relay station and network controller for data traffic between stations within its coverage area by providing a routing function on the WLAN side. Furthermore, an AP provides another routing function pertaining to the routing of downlink traffic originating from an upstream network (such as enterprise network 220 and IP backbone 100, as well as traffic originating from other APs) and destined for a WLAN station served by the AP.

Depending on the particular implementation, Wi-Fi networks are typically connected to IP backbone 100 via an Internet Service Provider (ISP) 226 or facilities provided by a host network, such as enterprise network 220. For example, in a home deployment, a Wi-Fi WLAN will typically be connected to the Internet via the use of a cable or DSL (Digital Subscription Line) modem, which in turn is connected to ISP facilities hosted by a cable data service provider or ISP. In other instances, an enterprise network operator may lease a line or multiple lines that are connected either directly to the IP backbone or via an appropriate gateway. Meanwhile, access to a Wi-Fi network is generally managed via either a host network (wherein the Wi-Fi network is a sub-net of the host domain), a stand-alone network managed by a LAN server or the like (e.g., network server 208), or via management measures built into the Wi-Fi APs themselves. For example, many Wi-Fi AP's provide built-in routers that support the capability of allocating IP addresses using DHCP (Dynamic Host Control Protocol). Wi-Fi APs generally also provide security measures to prevent unauthorized access, such as shared or rotating keys.

Each of FIGS. 1 and 2 further show network infrastructure for facilitating an exemplary use case in which handover between Wi-Fi and WiMAX networks might be employed. In this example, the use case is using Voice over IP (VoIP), also referred to as Internet Telephony. In brief, VoIP facilities enable phone calls to be carried over Internet infrastructure using a packetized transport. For illustrative purposes, the VoIP facilities depicted in FIGS. 1 and 2 are represented a VoIP provider network 118, a telecommunications (telco) network 120, and a telephone 121. As discussed above, embodiments are described herein to facilitate handover of wireless services from WiMAX networks to Wi-Fi networks and vice-versa. In the context of stand-alone Wi-Fi and WiMAX networks and combined Wi-Fi and WiMAX networks there are two types of handovers: intra-radio and inter-radio. In intra-radio handover pertains to handover between radios having the same type, such as handover between WiMAX base stations for an MSS. An inter-radio handover, which is the focus of the embodiments herein, applies to radio handover between Wi-Fi and WiMAX networks for combined Wi-Fi and WiMAX services. In the context of such combined Wi-Fi and WiMAX services, the same terminology of “mobile subscriber stations” (as also used in the WiMAX terminology) will be used herein to refer to mobile user devices, such as laptop and notebook computers, PDAs, pocket PCs, etc.

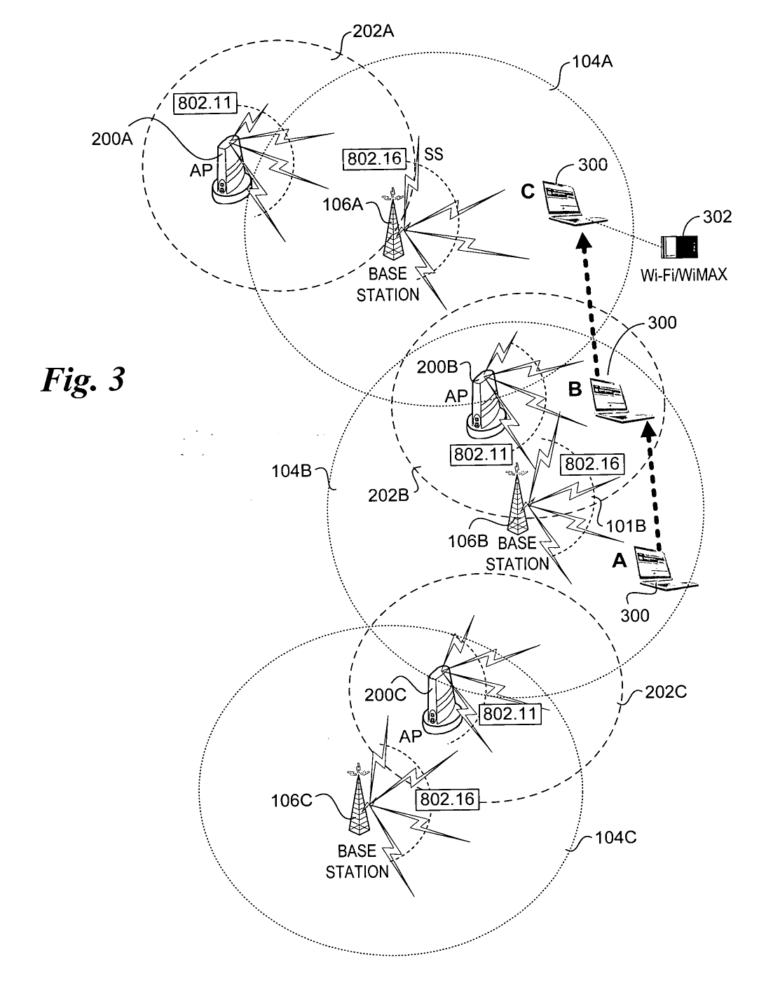

FIG. 3 illustrates the combined coverage areas of the WiMAX network of FIG. 1 and the Wi-Fi network of FIG. 2 when the networks are overlaid. As with the Wi-Fi AP coverage areas, the coverage areas (cells 104A-C) for respective base stations 106A-C are depicted as circles for simplicity. However, the “footprint” (i.e., shape) of each WiMAX coverage area will generally depend on the type of antenna (e.g., single sector, multiple sector or omni-directional) provided by the base station in combination with geographical and/or physical infrastructure considerations and the power of the radio signal. For example, although referred to as non-line-of-sight (NLOS), geographical terrain such as mountains and trees, and public infrastructure such as large buildings may affect the wireless signal propagation, resulting in a reduced coverage area. The radio signal strength for WiMAX transmissions are also limited by the available RF spectrum for licensed and/or licensed-free operations.

As illustrated in FIG. 3, there are some portions of coverage areas that overlap, while other portions are non-overlapping. Thus, as a mobile subscriber station moves through various coverage areas, there will be locations under which the combined network service will provide both Wi-Fi and WiMAX coverage, while in other areas only one type of service (Wi-Fi or WiMAX) will be available. As such, to support mobile device “roaming,” there will need to be some mechanism for switching between Wi-Fi and WiMAX services. Furthermore, such a mechanism should be able to determine under what conditions it is advantageous to switch from one service to the other.

Examples of these situations are illustrated in FIG. 3. At position “A”, an MSS 300 is within a single coverage area comprising the WiMAX cell 104B corresponding to Base Station 106B. At position “B”, MSS 300 is within two coverage areas: AP 200B's coverage area 202B and Base Station 106B's cell 104B. At position “C”, MSS 300 returns to a single coverage area comprising WiMAX cell 104A corresponding to Base Station 106A.

One type of handover illustrated in FIG. 3 is a required handover. Under a required handover, a handover must be performed from a first type of network to a second type of network (i.e., from WiMAX to Wi-Fi or from Wi-Fi to WiMAX), otherwise there will be a loss of connectivity as an MSS moves out of the coverage area of the first network. For example, for illustrated purposes assume that MSS 300 is currently employing Wi-Fi service from AP 200B at position “B”. As MSS 300 moves from position “B” to position “C”, it moves out of range of Wi-Fi AP 200B's coverage area 202B. Accordingly, somewhere along the path from position “B” to “C” a handover between Wi-Fi services provided by AP 200B and WiMAX services provided by base station 106A needs to be performed.

In some cases, conditions for performing an “opportunistic” handover may occur. For example, there may be implementations that prioritized Wi-Fi services over WiMAX services when both services are available or other situations where the service available from a Wi-Fi AP has higher QoS support than that currently provided by a WiMAX BS. Accordingly, as an MSS currently employing WiMAX service moves within range of a Wi-Fi AP, a handover to the AP may be performed such that the higher QoS priority and/or better performing Wi-Fi service is used. Such a situation is depicted in FIG. 3 when MSS 300 moves between position “A” and position “B”.

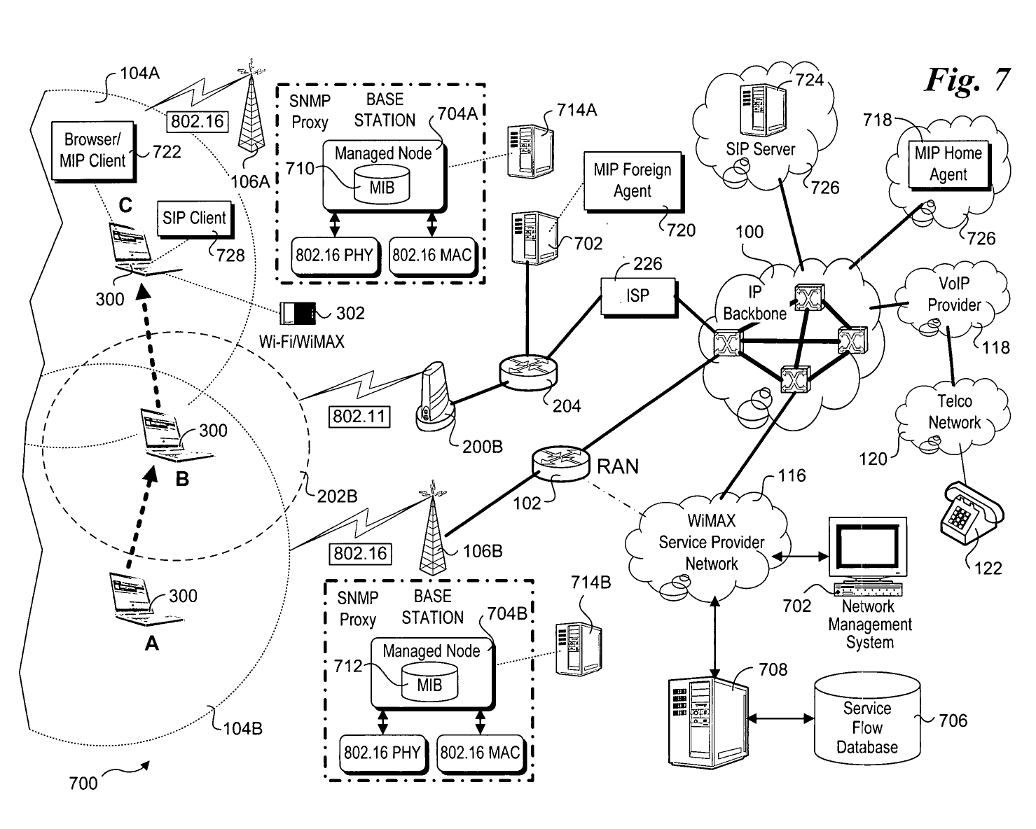

In general, an MSS that operates in a combined WiMAX and Wi-Fi network will need to provide wireless facilities (i.e., wireless interfaces) for communicating with both WiMAX Base Stations and Wi-Fi access points. For simplicity, such facilities are depicted as being provided by a combination Wi-Fi/WiMAX PCMCIA card 302 in FIG. 3 and FIG. 7. It will be understood that separate hardware may be implemented in place of a combination card. Furthermore, it will be understood that there are also software entities that are run on MSS 300 to facilitate Wi-Fi and WiMAX communication. For example, such components will typically include operating system drivers or the like.

Handover Decision

A important part of performing the handover is the handover (HO) decision. In brief, the handover decision involves a determination of whether to initiate a handover, and if so, when the handover is to occur.

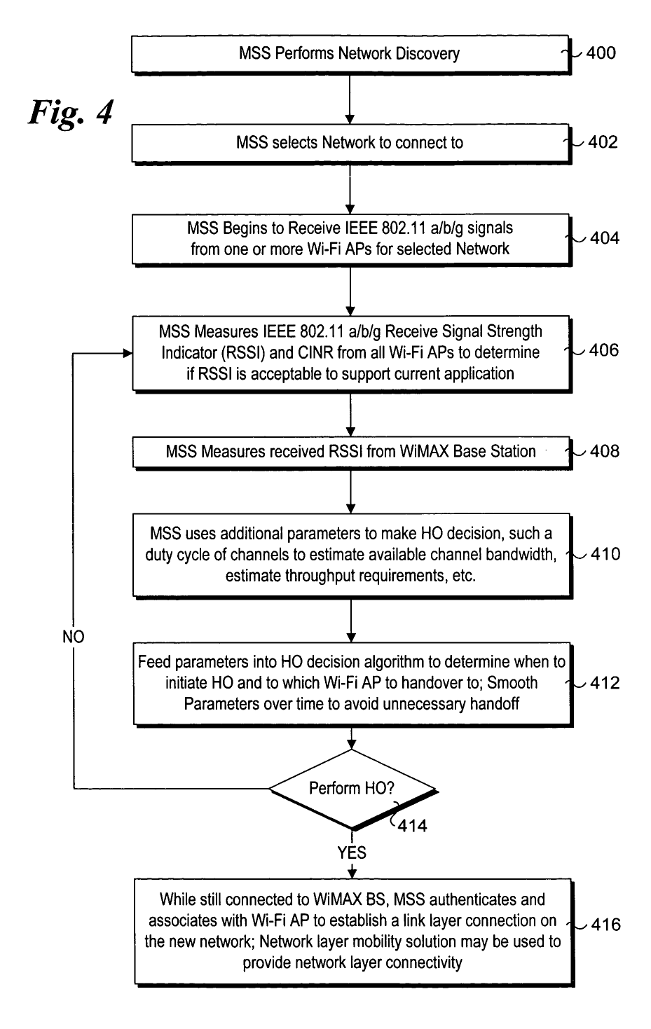

As an overview, reference is made to FIG. 4, which shows general operations performed in connection with a handover decision for a handover from a WiMAX network to a Wi-Fi network. It is presumed at the start of this process that an MSS is currently being serviced by a WiMAX network. The handover decision making process begins at a block 400 with network discovery. The MSS Media Independent Handover Function entity as defined in IEEE 802.21/D00.01 draft Standard (July, 2005) can discover and obtain network information existing within a geographical area for different wireless networks while receiving service from a current wireless network. The network information may include, for example, network type, network ID, channel information, security information, and MAC addresses for APs and base stations. Next, in a block 402, the MSS selects the network from among any available networks to which it needs to connect via a handover. In general, an MSS may determine which of the available wireless networks it needs to connect based on its specific requirements, such as QoS parameters, security, coverage area, etc.

Once the specific network is selected, the MSS power management function can turn-on the corresponding radio. In this current example, the selected network comprises a Wi-Fi network. Accordingly, in a block 404, the MSS turns its Wi-Fi radio on and begins to receive IEEE 802.11a/b/g signals from one or more Wi-Fi APs within its range. The Wi-Fi radio may be continuously scanning for Wi-Fi networks, or based on user/OS policies may be optimized for power saving and scan for network at appropriate time or when pre-defined events occur, e.g. lower signal quality on the other network.

In a block 406, the MSS measures link layers parameters, such as received IEEE 802.11a/b/g Receive Signal Strength Indicator (RSSI) and the Carrier-to-Interference Noise Ratio (CINR) from all the Wi-Fi APs within its range to determine if the received signal(s) is/are acceptable to support corresponding applications on the MSS, such as high-speed Internet access, Internet Telephony, etc. Usually the MSS will associate with the 802.11 AP having the highest signal strength; however this does not, taken alone, provide an indication of better throughput, as there may be several other stations already employing that AP for wireless service (thus consuming a portion of the available bandwidth and corresponding throughput for the AP). Under this situation, higher throughput might be obtained by using an AP with a lower signal strength that is servicing less traffic. In some instances, such as in hotels, the MSS may be within range of several Wi-Fi networks, wherein a specific network needs to be selected. Meanwhile, in conjunction with performing the signal strength measurement in block 406, the MSS also measures the received RSSI/CINR for the WiMAX Base Station currently providing its service, as depicted in a block 408.

Besides employing the RSSI measurements from the various APs, the MSS uses additional parameters to make its handover decision, as depicted in a block 410. Such parameters may include but are not limited to the duty cycle of the channels the MSS receives to get an estimate of the available bandwidth on a particular channel, estimated throughput requirements for the MSS application(s), the packet error rate (PER) and/or bit error rate (BER) of the current channel, the power consumption level expected from a specific radio at a specific data rate, etc. Collectively, the signal strength and additional parameters are used to quantify the wireless service available via an AP.

In a block 412, these parameters, e.g. the measured RSSI values, the duty cycles of the channels, the throughput requirements, etc., are fed into an handover decision algorithm (discussed below) to determine when to initiate the handover and to which Wi-Fi AP to handoff to. These variables are smoothed out over some time period to determine their trend in order to avoid unnecessary handoffs.

As depicted by a decision block 414, if it is determined that it is advantageous to switch network service from the WiMAX BS to an AP and the AP is known, then the process proceeds to a block 416 to perform the handover. If the determination of decision block 414 is NO, the process loops back to block 406, and the operations of blocks 406, 408, 410, 412, and 414 are repeated during a next iteration of the process.

In accordance with a YES answer to decision block 414, the handover process is initiated in a block 416. While still connected to the WiMAX Base Station, the MSS authenticates and associates with the Wi-Fi AP to establish a link layer connection on the new network. This is known as a “make before break” procedure, wherein a new link layer connection is made with the AP before breaking (releasing) the existing connection with the WiMAX BS. Other schemes are also at the discretion of the MSS, which may decide to use “break before make” if it finds it appropriate for the type of traffic it is currently carrying. A network layer mobility solution, such as Mobile IP, Session Initiation Protocol, or a similar application layer scheme such as network connection management is then used to provide network layer connectivity, as discussed in further detail below.

Once a specific Wi-Fi AP has been selected, the MSS could initiate a handover request based on some decision criteria. For example, the following lists three categories of decision algorithms; however, these are merely exemplary, and can be extended to others, as will be understood by those skilled in the wireless communication arts. The categories include:
A. Network conditions-based decision algorithm. Based on network conditions, such as estimated available bandwidth, channel conditions and throughput on a particular network, the handover algorithm selects the most appropriate network to handover to.
B. User policy-based decision algorithm. The handover decision is based on a user profile, e.g. home vs. office, free calling plan vs. cellular type of calling plan, time-of-day, power-consumption, etc.
C. Time-decision algorithm. This algorithm determines the appropriate time for the MSS to initiate or request a handover. In general, the time-decision algorithm provides better performance than the network condition-based algorithm. However, the time-decision algorithm is more complex, since it must process a range of parameters with different importance level to the handover decision such as:
   1. Link layer parameters (CINR, RSSI, etc.), packet error rate, bit error rate, etc.;
   2. Channel duty cycle;
   3. Required QoS parameters and length of session;
   4. Handover rate for the current session; and
   5. Network availability and coverage.

In one embodiment, aspects of the time-decision handover algorithm are combined with the user policy algorithm to decide on the optimal time to initiate a handover decision from a WiMAX BS to a Wi-Fi AP. (Note this approach may also be expandable to other combinations, such as combining aspects of the network conditions-based algorithm.) Furthermore, in one embodiment, the aspects of the separate and combined algorithms are implemented using fuzzy logic.

In further detail, “fuzzy” logic is an extension of Boolean logic dealing with the concept of partial truth. Fuzzy logic was introduced in 1962 by Prof. Lotfi Zadeh at the University of California, Berkeley. Whereas classical logic holds that everything (statements) can be expressed in binary terms (0 or 1, black or white, yes or no), fuzzy logic replaces boolean truth values with degrees of truth. These statement representations are in fact nearer to real-life human problems and statements, as truth and results are, in most of the time, partial (not binary) and/or imprecise (as in inaccurate, blurred, i.e., fuzzy). Fuzzy logic allows for set membership values between and including 0 and 1, shades of gray as well as black and white, and in its linguistic form, imprecise concepts like “slightly”, “quite” and “very”. Specifically, it allows partial membership in a set.

Fuzzy logic is often used in control systems and the like to generate control outputs based on a combined evaluation of multiple inputs that are quantified using associated fuzzy subsets (commonly referred to as “fuzzy sets”). Such uses include self-focusing cameras, washing machines, automobile engine controls, anti-lock braking systems, subway and elevator control systems, and computer trading programs. Fuzzy logic enables problems to be logically modeled, rather than using analog-based techniques employed by classical control system theory.

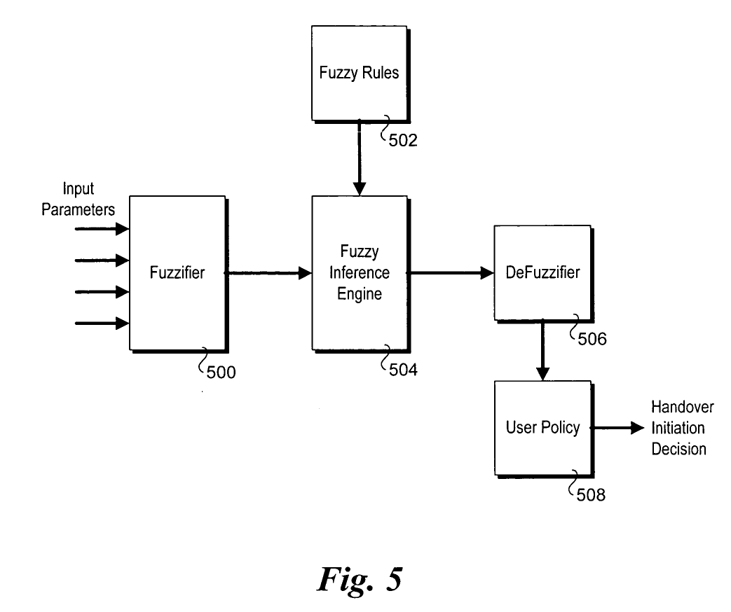

FIG. 5 shows one embodiment of fuzzy logic controller architecture for the handover decision algorithm comprising a combination of the time-decision and user-policy handover algorithms. The architecture consists of five key building blocks: a Fuzzifier 500, Fuzzy Rules base 502, a Fuzzy Inference Engine (FIE) 504, a Defuzzifier 506, and user policy 508. The various handover parameters (obtained above by the MSS) are applied as inputs to Fuzzifier 500, where they are mapped into fuzzy sets. Each fuzzy set indicates the “goodness” of a corresponding parameter. These fuzzy sets are passed to FIE 504, where a set of fuzzy rules is applied to the inputs to determine if the handover should occur at this time. The Defuzzifier 506 compares the two outcome values from FIE 504 using some-kind of adaptive threshold to decide whether to initiate a handover at this time. In one embodiment, an adaptive threshold in Defuzzifier 506 adjusts the threshold level based on changes in the input parameters and past history to effect an efficient handover. If the answer is YES, a trigger is set to a policy decision engine, where the policy rules defined in user profile 508 specify how a specific network should handle a handover event.

Fuzzy logic usually uses IF/THEN rules, or constructs that are equivalent, such as fuzzy associative matrices. Rules are typically expressed in the form:

IF variable IS set THEN action

In one embodiment, the fuzzy sets are set according to the following example. Let's define a fuzzy set STRONG using a membership function based on the (M)SS receiver RSSI—(As discussed above, the input parameters are smoothed out prior to being fed into the decision algorithm):

| | |
|---|---|
| STRONG(x) = {0, | if RSSI(x) < −40 dBm, |

| | |
|---|---|
| (RSSI(x) + 40 dBm), | if −40 dBm <RSSI(x) ≦ 0 |
| 1, | if RSSI(x) > 0} |

Thus, the degree that the RSSI received at an (M)SS is strong is defined by the fuzzy set STRONG.

Similarly, let's define a fuzzy set GOOD_Signal using a membership function based on the (M)SS receiver CINR:

| GOOD_Signal(x) = {0, | | if CINR(x) < 26.2 dB for |
|---|---|---|
| | | 16-QAM ¾ modulation |
| | CINR − 26.2 dB, | if 26.2 dB < CINR ≦ 40 dB for |
| | | 16-QAM ¾ modulation |
| | 1, | if CINR(x) > 40 dB for |
| | | 16-QAM ¾ modulation} |

We have defined two fuzzy sets, namely STRONG and GOOD_Signal for the (M)SS receiver RSSI and CINR, respectively. A simple fuzzy rule can be written as follows:

A=X is STRONG and X is GOOD_Signal

where the “and” statement is interpreted according to:

truth(x and y)=minimum(truth(x), truth(y))

Other fuzzy sets can be easily defined for other input parameters in a similar manner, and additional fuzzy rules can be applied based on user profile and network availability.

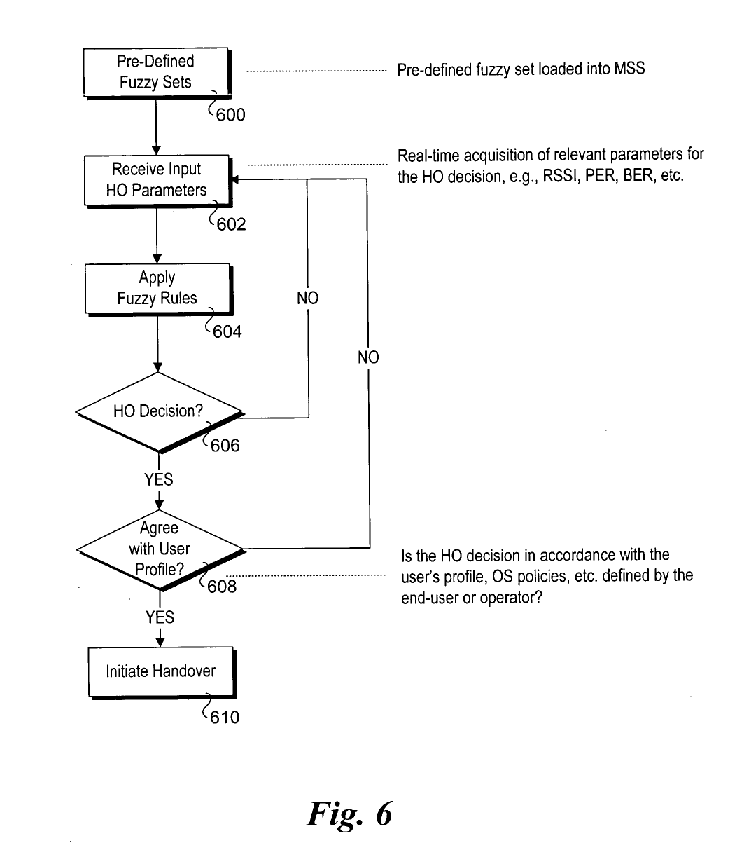

FIG. 6 shows, for example, operations and logic for a time-decision handover algorithm that can be implemented in an MSS using the fuzzy logic controller of FIG. 5. During an initialization operation or the like, pre-defined fuzzy sets are loaded into the controller in the MSS, as depicted in a block 600. In a block 602, the MSS performs real-time acquisition of the relevant handover parameters used to quantify the available wireless service, such as RSSI, PER, BER, QoS, network availability, etc., which are mapped into the pre-defined fuzzy sets. Then, in a block 604, the MSS controller applies the fuzzy rules to determine if it is O.K. to proceed to a handover decision. An MSS fuzzy rule might be, for example, if the PER is above X % and the RSSI is below Y % then update the received input parameters and select another network or AP. As depicted by decision blocks 606 and 608, if the handover decision is YES, a check is made to determine if the handover decision is in agreement with the end-user's profile, operating system policies, etc. as defined by the end-user or network operator. If they are in agreement, the handover is initiated in a block 610. If the answer to either decision block 606 or 608 is NO, the process loops back to block 602, and the operations of blocks 602, 604, 606, and 608 are repeated during a next iteration.

Another aspect of a handover concerns the context to be maintained across the handover (i.e., before, during, and after the handover process). Generally, there are two types of contexts for which a handover is performed. The first is a connection context, wherein it is required to maintain a connection across the handover. For example, this situation might occur if an MSS was being used for a voice telephony call—one needs to maintain the call connection (and thus the corresponding connection context) throughout the handover. The second type of handover context pertains to a connectionless context. In this situation, there is no connection (per se) established, and thus no connection context to maintain during the handover. An example of this situation occurs when an MSS is being used to access the Internet for interactive Web usage (e.g., Web surfing).

To facilitate a connection context during a handover across combined Wi-Fi and WiMAX services, there needs to be some infrastructure and associated communication (e.g., messaging) to “share” management of the connection context on a per-connection basis. For example, under the examples of FIG. 1 and FIG. 2, each of the exemplary WiMAX and Wi-Fi networks were configured as discreet (i.e., independent) networks. However, in order to support seamless service, there needs to be some level of coordination between various infrastructure elements for the respective networks.

One aspect that distinguishes WiMAX networks from Wi-Fi networks is service provisioning. To enable end-user access to a WiMAX network, the user's (M)SS and service flows (i.e., unidirectional flow of MAC service data units on a connection with a particular quality of service (QoS)) must be provisioned. Unlike the limited QoS support provided by the more simplistic Wi-Fi networks, WiMAX's IEEE 802.16-based network architecture supports a rich set of QoS features. Furthermore, WiMAX networks employ a more sophisticated wireless air-interface (than does Wi-Fi) that supports “true” QoS services, and thus requires more complex service provisioning considerations.

More specifically, WiMAX is based on centralized control architecture, where the scheduler in a given BS has complete control of the wireless media access among all SS's and MSS's that are currently using that BS for network access. WiMAX-based network architecture can simultaneously support multiple wireless connections that are characterized with a complete set of QoS parameters. Moreover, this architecture provides the packet classifier to map these connections with various user applications and interfaces, ranging from Ethernet, TDM (Time-Division Multiplexing), ATM (Asynchronous Transfer Mode), IP (Internet Protocol), VLAN (Virtual Local Area Network), etc. However, the rich feature set and flexibility in WiMAX also increases the complexity in the service deployment and provisioning for fixed and mobile broadband wireless access networks.

FIG. 7 shows one embodiment of a network infrastructure 400 including combined aspects of the WiMAX network of FIG. 1 and the Wi-Fi network of FIG. 2, wherein like-numbered components perform similar functions. Under the embodiment illustrated in FIG. 7, WiMAX network management operations are facilitated by deploying WiMAX base stations as managed nodes. This may be deployed through use of a facilities defined by a management reference model for a WiMAX Broadband Wireless Access (BWA) network. The management reference model includes a Network Management System (NMS) 702, managed base station nodes (depicted as managed nodes 704A and 704B for base stations 106A and 106B), and a Service Flow Database 706 hosted by a database server 708. The NMS 702 and Service Flow Database 706 are linked in communication to the WiMAX network's base stations via applicable network infrastructure, such as illustrate in FIG. 7. It is noted that other communication infrastructure also may also be employed.

In one embodiment, the BS managed nodes collect and store managed objects in an 802.16 Management Information Base (MIB) format, as depicted by MIB instances 710 and 712. In one embodiment, managed objects are made available to NMSs (e.g., NMS 402) using the Simple Network Management Protocol (SNMP) as specified by IETF RFC (request for comments) 1157. In further detail, managed node aspects of base stations are typically performed locally or remotely for a given base station using corresponding computer hardware or the like, such as depicted by base station servers 714A and 714B in FIG. 4.

Unlike a WiMAX network, most Wi-Fi networks are stand-alone, either for networks having just a single AP node (e.g., home Wi-Fi network), or multiple AP nodes (e.g., an enterprise network). This creates a dilemma with respect to shared access to combined Wi-Fi and WiMAX infrastructure. More specifically, the network layer connection for each of the WiMAX and Wi-Fi networks typically will employ two different IP addresses for the same MSS. Thus, during a handover, data that is currently being routed to a first IP address (e.g., the IP address for the MSS as assigned by the WiMAX network) needs to be rerouted to a second IP address (e.g., the IP address for the MSS as assigned by a Wi-Fi network).

There are two basic options for addressing this problem. As a first option, the WiMAX and Wi-Fi networks may be deployed as a combination network that is centrally managed, wherein a central authority or the like (e.g., a service provider) is employed for managing the various subscribers. This is somewhat akin to the approach used by a cellular service provider. (It is noted that a centrally managed scheme does not imply that all management operations are implemented at a single central facility, but rather the management operations and decisions are performed under the direction of a central authority.) The second option employs a more distributed approach. Under this scheme, decisions and operations are managed by distributed elements that may or may not be directed by a single central authority. These include decisions made by agents or the like running on a mobile device. FIG. 7 further illustrates examples of two distributed approaches, including a Mobile IP (MIP implementation) and a Session Initiation Protocol (SIP) implementation.

The Internet Protocol (IP) was originally designed to interconnect heterogeneous wired networks. This property of IP to integrate networks, is inherited by its Mobile IP (MIP) extension that focuses on mobile environments. Originally, MIP was designed as a solution to the problem of node portability. However, further extensions to MIP and existing research have indicated that MIP can also provide mobility support.

MIP introduces three new network entities, namely the Home Agent (HA), Foreign Agent (FA) and Mobile Node (MN). Every Mobile Node (an MSS in the present implementation) is permanently allocated an IP address in its Home Network. In turn, the Home Network hosts a Home Agent. More specifically, a Home Agent is defined as a router with at least one interface on the Mobile Node's home link. Every time that a Mobile Node moves so that it is connected via a new connection, it is required to register its current point of attachment (POA) to the network (e.g., Internet) with the Home Agent. For each registered Mobile Node, the Home Agent acts as a proxy in the home network, intercepting incoming traffic and redirecting it through packet encapsulation (i.e., tunneling the incoming traffic) to the Mobile Node's most recently registered location (also referred to as its care-of-address (CoA) for MIPv6). Through registering its new location with the Home Agent, it enables the redirection of traffic from various Content Provider (CP) to the Mobile Node. CPs are also known in Mobile IP as Correspondent Nodes (CNs). For MIP, the underlying network platform that provides the IP service is transparent. As such, the problem of integrating heterogeneous network platforms that can support Internet services is reduced to a matter of routing.

A Foreign Agent comprises a router on a foreign link that assists the Mobile Node in informing its Home Agent of its current CoA. A Foreign agent sometimes provides a COA and de-tunnels packets for the Mobile Node. It also may act as the default router for packets generated by the Mobile Node while connected to this foreign link.

To facilitate MIP operations, corresponding software entities are deployed for each of the Mobile Node, Home Agent, and Foreign Agent. As illustrated in FIG. 7, these include a MIP Home Agent 716 running on host computer (not shown) in a home network 718. Additionally, an MIP Foreign Agent 720 is run on server 702, and a MIP client 722 is run on MSS 300, which operates as the Mobile Node. In one embodiment, functionality for MIP client 722 is built into a browser running on MSS 300. In one embodiment, an MIP Agent is hosted by the WiMAX service provider.

Suppose that an operator of MSS 300 wishes to place a call to telephone 122 via VoIP provider 118, which comprises the MIB Content Provider in this example. Rather than contact the VoIP provider directly, the call request is issued via MIP Home Agent 716, which acts as a proxy for MSS 300. The result of this is that it appears to VoIP provider 118 that MIP Home Agent 716 is placing the call request, and thus the call request is being made by an endpoint having a fixed IP address. Meanwhile, as MSS moves to different POAs (such as from WiMAX BS 106B at position “A” to AP 200B at position “B”), its current IP address (its CoA) changes. These changes are handled by MIP Home Agent 716 and MIP client 722 in a manner that is transparent to VoIP provider 118.

In another embodiment, software and network entities for facilitating the Session Initiation Protocol (SIP) are employed. The Session Initiation Protocol works in concert with various protocols that are employed to carry various forms of real-time multimedia session data, such as voice, video, and text messages protocols by enabling Internet endpoints (called user agents) to discover one another and to agree on a characterization of a session they would like to share. For locating prospective session participants, and for other functions, SIP enables the creation of an infrastructure of network hosts (called proxy servers) to which user agents can send registrations, invitations to sessions, and other requests. SIP is an agile, general-purpose tool for creating, modifying, and terminating sessions that works independently of underlying transport protocols and without dependency on the type of session that is being established.

SIP is an application-layer control protocol that can establish, modify, and terminate multimedia sessions (conferences) such as Internet telephony calls. Additionally, SIP transparently supports name mapping and redirection services, which supports personal mobility—users can maintain a single externally visible identifier regardless of their network location.

As depicted in FIG. 7, an SIP session in implemented via an SIP server 724 residing in a network 726 and a SIP client 728 running on MSS 300. In general, the SIP server functions in a manner similar to an MIP Home Agent, wherein from the viewpoint of the content provider (e.g., VoIP Provider 718 in the illustrated example), content is being provided to SIP server 724 rather than MSS 300. As MSS 300 changes its network attachment point, SIP client 728 updates its current IP address. Accordingly, SIP server 724 functions as a proxy to MSS 300 by redirecting packets to the current IP address for MSS 300.

Exemplary MSS Architecture

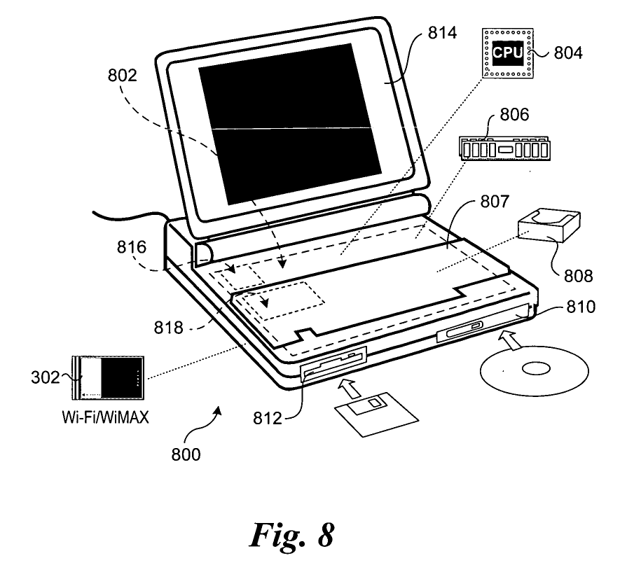

FIG. 8 shows one embodiment of an MSS implemented via a host notebook computer 800. It will be understood that this is merely exemplary of various types of host devices that may be employed for an MSS, such as but not limited to notebook computers, hand-held computers (e.g., pocket PCs), PDA, cellular telephones, etc. Notebook computer includes a chassis in which various components are installed, including a main board 802 on which a processor 804 and memory 806 are installed. A keyboard 807 is mounted on the chassis and coupled to main board 802 to enable data entry and the like. Also housed within the chassis are several peripheral components, including a disk drive 808, a CD-ROM or combination CD-ROM/DVD-ROM 810 and an optional floppy drive 812. The main board also includes circuitry (e.g., a graphics chip) for driving a display 814 coupled to the chassis. The various circuit components are powered via a power conditioner 816 (when the notebook is plugged into an AC outlet) and a battery 818 (when mobile).

As discussed above, the wireless facilities (i.e., interfaces) provided by an MSS may be implemented via built-in circuitry, add-on cards, or a combination of the two. In the illustrated embodiment, a combination Wi-Fi/WiMAX PCMCIA card 320 provides this functionality. In other configurations, each of the Wi-Fi and WiMAX wireless interfaces may be provided on separate PCMCIA cards, or appropriate circuitry for facilitating at least one Wi-Fi or WiMAX interface may be built into notebook computer 800.

As also discussed above, various operations of the embodiments herein are facilitated via corresponding software entities running on various hosts in the networks. Thus, embodiments of this invention may be used as or to support software instructions executed upon some form of processing core or otherwise implemented or realized upon or within a machine-readable medium. A machine-readable medium includes any mechanism for storing or transmitting information in a form readable by a machine (e.g., a computer). For example, a machine-readable medium can include a read only memory (ROM); a random access memory (RAM); a magnetic disk storage media; an optical storage media; and a flash memory device, etc. In addition, a machine-readable medium can include propagated signals such as electrical, optical, acoustical or other form of propagated signals (e.g., carrier waves, infrared signals, digital signals, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method comprising:
receiving, at a mobile subscriber station (MSS), wireless service from a first wireless network;
detecting the MSS is within range of at least one base station for a second wireless network;
for each of the at least one base station, obtaining parameters quantifying the wireless service available via that base station; and
employing the parameters in a handover decision algorithm to determine if a handover of service from the first wireless network to the second wireless network is to be performed.

2. The method of claim 1, wherein the handover decision algorithm is implemented via the use of a fuzzy logic controller that employs the parameters that are obtained as inputs.

3. The method of claim 1, wherein the parameters include at least one of:
a Receive Signal Strength Indicator (RSSI);
a Carrier-to-Interference Noise Ratio (CINR);
a packet error rate (PER);
a bit error rate (BER); and
a throughput rate.

4. The method of claim 1, wherein the handover decision algorithm comprises a network conditions-based algorithm under which the handover decision algorithm selects a most appropriate network to handover to or remain with based on network conditions for each of the first and second wireless networks.

5. The method of claim 1, wherein the handover decision algorithm comprises a user-policy-based algorithm under which the handover decision is based on a user profile for a user associated with the MSS.

6. The method of claim 1, wherein the handover decision algorithm comprises a time-decision algorithm under which the algorithm determines an appropriate time for an MSS to initiate or request a handover.

7. The method of claim 1, wherein the handover decision algorithm comprises a combination of a time-decision algorithm under which the algorithm determines a time for an MSS to initiate or request a handover and a user policy-based algorithm under which the handover decision is based on a user profile of a user associated with the MSS.

8. The method of claim 1, further comprising:
performing a handover from the first wireless network to the second wireless network.

9. The method of claim 8, wherein the handover is a make before break handover under which link-layer connectivity is established with the second network prior to releasing a connection with the first network.

10. The method of claim 8, wherein a connection context is maintained across the handover.

11. The method of claim 10, wherein the connection context is maintained across the handover by employing Mobile Internet Protocol (MIB) facilities including an MIB client on the MSS.

12. The method of claim 10, wherein the connection context is maintained across the handover by employing Session Initiation Protocol (SIP) facilities including an SIP client on the MSS.

13. The method of claim 1, wherein the first wireless network comprises a WiMAX network, and the second wireless network comprises a Wi-Fi network.

14. The method of claim 1, wherein one of the first and second networks comprise a cellular network.

15. A machine-readable medium to provide instructions to execute on a mobile subscriber station (MSS) to perform operations comprising:
obtaining parameters quantifying wireless service available via at least one access point (base station) the MSS comes within range of while receiving wireless service from a base station corresponding to a first wireless network, the at least one base station used to access a second wireless network; and
employing the parameters obtained for the at least one base station in a handover decision algorithm to determine if a handover of wireless service from the base station to a base station is to be performed.

16. The machine-readable medium of claim 15, wherein execution of the instructions implement a fuzzy logic controller that is used to effect the handover decision algorithm, and wherein the parameters that are obtained for the at least one base station are provided as inputs to the fuzzy logic controller.

17. The machine readable medium of claim 16, wherein the fuzzy logic controller includes a user policy block that is implemented to consider further parameters contained in a user-profile for a user associated with the MSS in performing the handover decision.

18. The machine readable medium of claim 15, wherein the handover decision algorithm comprises a network conditions-based algorithm under which the handover decision algorithm selects a most appropriate wireless network to handover to or remain with based on network conditions for each of the networks associated with the base station and that at least one base station.

19. The machine readable medium of claim 15, wherein the handover decision algorithm comprises a time-decision algorithm under which the algorithm determines an appropriate time for an MSS to initiate or request a handover.

20. The machine readable medium of claim 15, wherein the handover decision algorithm comprises a combination of a time-decision algorithm under which the algorithm determines an appropriate time for an MSS to initiate or request a handover and a user policy-based algorithm under which the handover decision is based on a user profile of a user associated with the MSS.

21. An apparatus, comprising:
a processor;
a first interface operatively coupled to the processor, to facilitate wireless communications via a wireless local area network (WLAN);
a second interface operatively coupled to the processor, to facilitate wireless communications via a wireless broadband network;
first and second omnidirectional antennas, respectively coupled to the first and second interfaces; and.
a storage device having instructions stored therein to perform operations when executed on the processor, comprising,
obtaining parameters quantifying wireless service available from each of at least one WLAN base station the apparatus comes within range of while receiving wireless service from a wireless broadband network base station; and
employing the parameters obtained for the at least one WLAN based station in a handover decision algorithm to determine if a handover of wireless service from the WLAN base station to a wireless broadband network base station is to be performed.

22. The apparatus of claim 21, wherein execution of the instructions one the processor implements a fuzzy logic controller that is used to effect the handover decision algorithm, and wherein the parameters that are obtained for the at least one WLAN base station are provided as inputs to the fuzzy logic controller.

23. The apparatus of claim 22, wherein the fuzzy logic controller effects a handover decision algorithm comprising a combination of a time-decision algorithm under which the algorithm determines an appropriate time for a mobile subscriber station to initiate or request a handover and a user policy-based algorithm under which the handover decision is based on a user profile of a user associated with the apparatus.
